(19) United States
(12) Patent Application Publication
(10) Pub. No.: US 2004/0233673 A1
(43) Pub. Date: Nov. 25, 2004

(54) SCANNER THAT CAN GENERATE UNIFORM LIGHT

(76) Inventor: Zheng Wang, Su-Chou City (CN)

Correspondence Address: NAIPO (NORTH AMERICA INTERNATIONAL PATENT OFFICE), P.O. BOX 506, MERRIFIELD, VA, 22116, US

(21) Appl. No.: 10/709,610

(22) Filed: May 18, 2004

(30) Foreign Application Priority Data
May 20, 2003 (TW) 092113639

(51) Int. Cl. F21V 7/04

(52) U.S. Cl. 362/307; 362/223

(57) ABSTRACT

A scanner includes a light source, a reflect piece, a lens, and a sensor. The light source generates light. The reflective piece includes one protrusion for reflecting the light from the light source. The lens transmits the light from the light source and the reflect piece. The sensor detects the light from the lens.

### BACKGROUND OF INVENTION

1. Field of the Invention

The present invention relates to a scanner, and more particularly, to a scanner that can generate uniform light.

2. Description of the Prior Art

The typical method for capturing an image with a scanner requires using a light source to illuminate a document, the light reflecting from the document being transmitting to a sensor through a lens. Because the document has dark sections reflecting less light and light sections reflecting more light, the sensor senses different intensities of light from different sections and transforms the reflective light into digital data represented by binary values 0 and 1. Finally, software of the scanner saves the digital data as an image file. Most scanners use a charge coupled device (CCD) as the sensor and a florescent tube as the light source. An ideal light source must have uniform light distribution. However, because properties of the tube and the lens, such as the length from the two ends of the tube to the two ends of the CCD being longer than the length from the center of the tube to the center of the CCD, the center of the CCD senses brighter light. For this reason, a reflective piece having a dark section according to the light distribution of the tube is installed at the back of the tube so that the CCD can receive uniform light.

Please refer to FIG. 1. FIG. 1 is a perspective view of the reflective piece 10 according to the prior art. The color and material of the reflective piece 10 are designed according to the light distribution of the tube. The reflective piece 10 comprises a dark section 14 and a light section 16. The dark section 14 absorbs more light than the light section 16, and the light section 16 reflects more light than the dark section 14. The center of the tube is brighter than the two ends of the tube, so the light section 16 of reflective piece 10 is decreasingly distributed from the two ends of the reflective piece 10 to the center of the reflective piece 10. That is to say, the reflective piece 10 has more of dark section 14 located at the center and more light section 16 located at the two ends. In this way, the dark section 14 absorbs more light from the center of the tube, and the light section 16 reflects more light from the two ends of the tube, so that the CCD receives as uniform as possible light intensity through the lens from the center and the two ends of the tube.

Please refer to FIG. 2. FIG. 2 shows graphs of light intensity curves of light received by the CCD. Curve CCD1 is an ideal light intensity curve, curve CCD2 is an actual light intensity curve of the tube, while CCD3 is a light intensity curve using the reflective piece 10. The ideal light intensity curve is between an upper limit L+ and a lower limit L−. The curve being above the upper limit L+indicates the light is too bright, and the curve being under the lower limit L−indicates the light is too dark. Before using the reflective piece 10, light, as the curve CCD2 shows, is seriously reduced at the two ends of the tube. After using the reflective piece 10, as the curve CCD3 shows, the light from the center of the tube is decreased but above the lower limit L−, and the two ends of the curve are more or less evenly bright. The reflective piece 10 improves the problem of insufficient light at the two ends of the tube. However, according to this method, the CCD cannot receive light of adequate uniform light intensity.

From the above description, the scanner uses the tube as the light source, but the tube has the problem of the center being brighter than the two ends. The reflective piece 10 is installed at the back of the tube to reduce this problem. After using the reflective piece 10, the CCD receives reduced light from the center of the tube and more light from the two ends of the tube. The reflective piece 10 partially solves the problem of the tube, however, the light distribution of the tube is not uniform, and such variance in light intensity decreases the quality of the scanner.

### SUMMARY OF INVENTION

It is therefore a primary objective of the claimed invention to provide a scanner that can generate uniform light to solve the above-mentioned problem.

According to the claimed invention, a scanner comprises a light source for generating light; a reflective piece having one protrusion for reflecting the light from the light source; a lens for transmitting the light from the light source and the reflective piece; and a sensor for detecting the light from the lens.

According to another claimed invention, a scanner comprises a light source for generating light; a reflective piece for reflecting the light from the light source, the reflective piece having a dark section decreasingly distributed from the center to the two sides of the reflective piece for absorbing part of the light from the light source, and two protrusions located at the two sides of the dark section for reflecting part of the light from the light source to the two sides of the light source; a lens for transmitting the light from the light source and the reflective piece; and a sensor for detecting the light from the lens.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a perspective view of a reflective piece according to prior art.

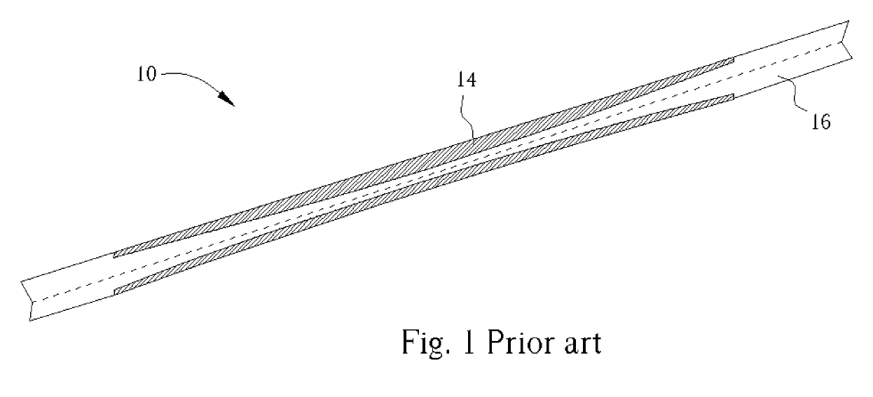

FIG. 2 shows graphs of light intensity curves received by the CCD.

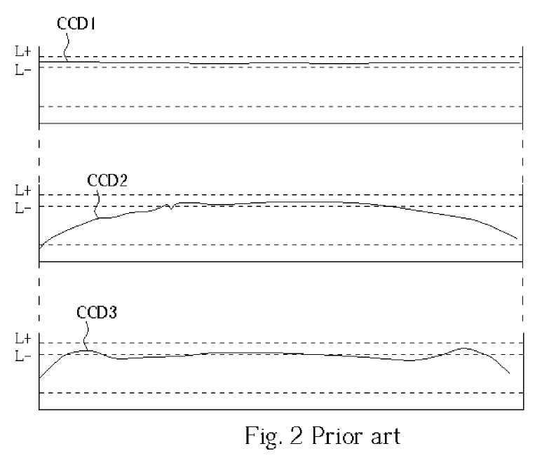

FIG. 3 is a schematic view of a scanner according to the present invention.

FIG. 4 is a perspective view of a first reflective piece according to the present invention.

FIG. 5 shows graphs of light intensity curves received by the CCD according to the present invention.

FIG. 6 is a perspective view of a second reflective piece according to the present invention.

FIG. 7 shows light intensity curves received by the CCD according to the present invention.

### DETAILED DESCRIPTION

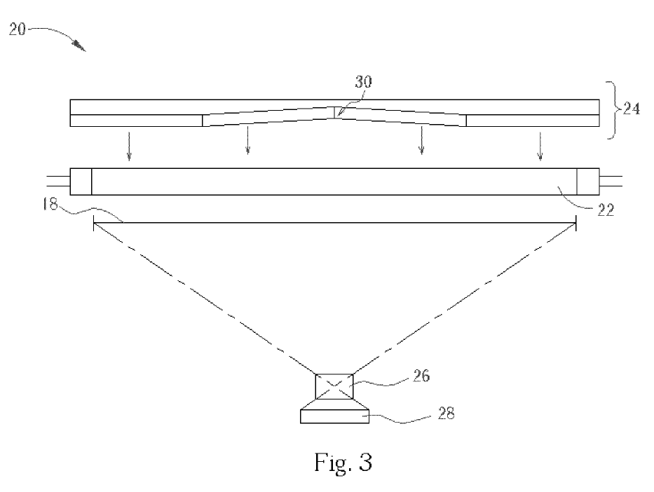

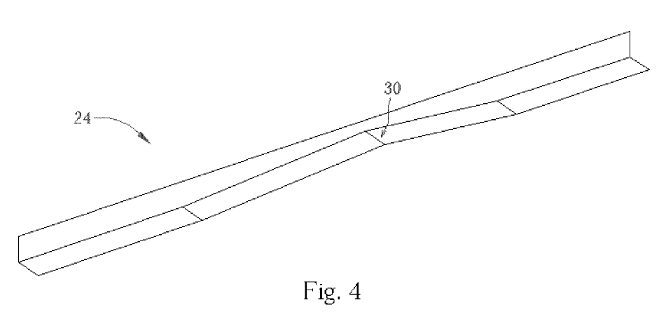

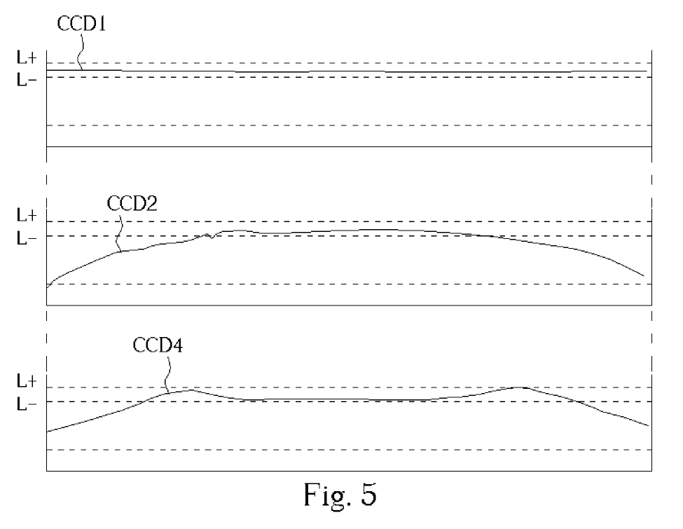

Please refer to FIG. 3 to FIG. 5. FIG. 3 is a schematic diagram of a scanner 20 according to the present invention. FIG. 4 is a perspective view of a first reflective piece 24 according to the present invention. FIG. 5 illustrates light intensity curves according to the present invention. The scanner 20 comprises a tube 22, the reflective piece 24, a lens 26, and a CCD 28. The scanner 20 uses the tube 22 to illuminate a document 18, and the CCD 28 receives the light through the lens 26 reflected from the document 18. The CCD 28 senses the different light intensities reflected from the different sections of the document 18. Because the tube 22 is brighter at the center and darker at the two ends, the reflective piece 24 is used to improve the light distribution. As shown in FIG. 4, the reflective piece 24 has a protrusion 30 located corresponding to the center of the tube 22. The peak of the protrusion 30 is located corresponding to the center of the tube 22, and the right and left slopes are extended corresponding to the two ends of the tube 22. The two slopes reflect part of the light from the center of the tube 22 to the two sides of the tube 22 so that the CCD 28 can receive uniform light. As shown in FIG. 5, a curve CCD1 is an ideal light intensity curve, a curve CCD2 is a light intensity curve of the tube 22, and a CCD4 is a light intensity curve using the reflective piece 24. After applying the reflective piece 24, the uneven light distribution, particularly at the two ends of the tube 22, is improved.

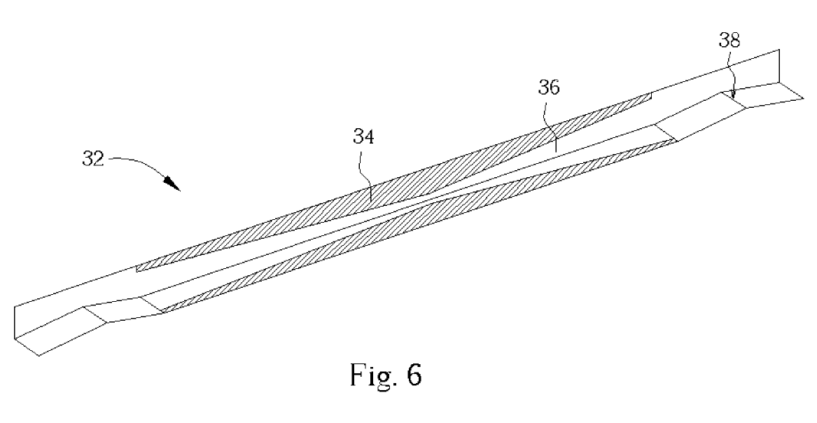

Please refer to FIG. 6. FIG. 6 is a perspective view of a second reflective piece 32 according to the present invention. After applying the reflective piece 24, the uneven light distribution, particularly at the two ends of the tube 22, is improved. As shown in FIG. 6, in a preferred embodiment according to the present invention, the reflective piece 32 has a dark section 34 and a light section 36. The reflective piece 32 further has two protrusions located at the two ends of the reflective piece 32 respectively. The dark section 34 absorbs more light than the light section 36, and the light section 36 reflects more light than the dark section 34. The light section 36 is decreasingly distributed from the two ends to the center of the reflective piece 32 according to the light distribution of the tube 22. Because of the dark section 34 and the light section 36 of the reflective piece 32, the CCD 28 receives the most light at the two ends of the tube 22. Two protrusions 38 are located corresponding to the two brightest sections for reflecting part of the light to the two sides of the two brightest sections. In this way, the CCD 28 can receive uniform light intensity from the length of the tube 22.

Each protrusion 38 reflects light to the two sides of the located section. The protrusion 38 of the reflective piece 32 is triangular or arc-shaped. For example, consider the platform of the scanner 20 being about A4 (210 mm*297 mm) in size, the length of the tube being 238 mm, and the scanning section being 216 mm. Because of the dark section 34 and light section 36, the CCD 28 receives the highest light intensity at an inner 20 mm from the two ends of the tube 22. Thus, the two triangular protrusions 38 is 2 mm high at the inner 20 mm from the two sides of the reflective piece 32. The protrusion 38 has a right and a left slope. The horizontal length of the slope is 15 mm. The surface of the slope is light section 36. With the protrusion 38, the reflective piece 32 can reflect part of the light to the two sides of the brightest section so that the CCD 28 can receive uniform light intensity from the tube 22.

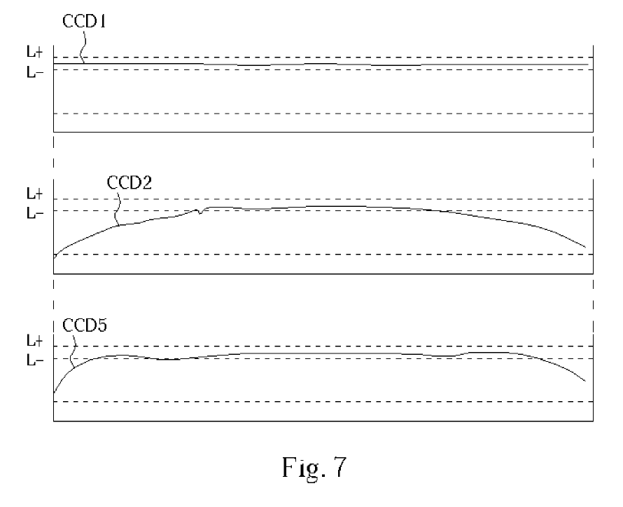

Please refer to FIG. 7. FIG. 7 illustrates light intensity curves received by the CCD 28. The curve CCD1 is the ideal light intensity curve, the curve CCD2 is a light intensity curve of the tube 22, and a curve CCD5 is a light intensity curve using the reflective piece 32. The ideal light intensity curve is between an upper limit L+ and a lower limit L−. Because the tube 22 is brighter at the center and darker at the two ends, the light, as curve CCD2 shows, is seriously reduced at the two ends of the tube. After the reflective piece 32 is installed at the back of the tube 22, the CCD 28 receives a light distribution tending to the ideal, as curve CCD5 shows. The curve CCD5 decreases gently at two ends of the tube 22 but everywhere is between the upper limit L+ and the lower limit L−.

From the above description, the protrusion 30 of the reflective piece 24 is located according to the light distribution of the tube 22 to reflect part of the light from the brighter section to the darker section of the tube to reduce the problem of uneven light distribution. For the CCD 28 to receive uniform light, in the preferred embodiment according to the present invention, the protrusions 38 of the reflective piece 32 are located at the brightest sections resulting from the dark section 34 and the light section 36, that is, the location corresponding to the two ends of the tube 22. The protrusions 38 can be adjusted to suit the light profile provided by the dark section 34 and the light section 36 to reflect part of the light of the brighter section to the darker section of the tube 22. After the reflective piece 32 is installed, the CCD 28 receives a light profile tending to the ideal curve.

In contrast to the prior art, the reflective piece according to the present invention allows the tube to generate uniform light thereby solving the problem of low light intensity at the two ends of the tube. The reflective piece according to the prior art only improves the problem of the darker two ends of the tube, and results in the brightest sections being at the two ends of the tube decreasing the quality of the scanner. The reflective piece according the present invention has two protrusions installed at the two ends of the reflective piece respectively to reflect part of the light to the two sides of the brightest section so that the CCD receives a nearly ideal light profile, enhancing the quality of the scanner.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A scanner comprising:
a light source for generating light;
a reflective piece including one protrusion for reflecting the light from the light source;
a lens for transmitting the light from the light source and the reflective piece; and
a sensor for detecting the light from the lens.

2. The scanner of claim 1 wherein the protrusion is located at the center of the reflective piece for reflecting part of the light from the light source to two sides of the light source.

3. The scanner of claim 1 wherein the reflective piece further comprises a dark section decreasingly distributed from the center to the two sides of the reflective piece for absorbing part of the light from the light source.

4. The scanner of claim 3 wherein the reflective piece comprises two protrusions located at two sides of the dark section for reflecting the part of the light from the light source to the two sides of the light source.

5. The scanner of claim 1 wherein the protrusion of the reflective piece is triangular.

6. The scanner of claim 1 wherein the protrusion of the reflective piece is arc-shaped.

7. The scanner of claim 1 wherein the scanner is a paper feed scanner.

8. The scanner of claim 1 wherein the scanner is a flatbed scanner.

9. The scanner of claim 1 wherein the light source is a fluorescent tube.

10. The scanner of claim 1 wherein the sensor is a charge coupled device (CCD).
